(19) United States
(12) Patent Application Publication
(10) Pub. No.: US 2008/0246595 A1
(43) Pub. Date: Oct. 9, 2008

(54) LANE GUIDE FOR MOTOR VEHICLES

(76) Inventor: Daniel William Sanders, Blaine, MN (US)

Correspondence Address: MOORE & HANSEN, PLLP, 225 SOUTH SIXTH ST, MINNEAPOLIS, MN, 55402, US

(21) Appl. No.: 11/695,703

(22) Filed: Apr. 3, 2007

(51) Int. Cl. B60Q 1/00

(52) U.S. Cl. 340/438

(57) ABSTRACT

Devices and methods for aiding drivers in properly positioning a motor vehicle within the lane of a roadway. Devices include visible indicia displayed on the vehicle windshield. The indicia can be positioned such that when the vehicle is properly positioned with respect to the left and/or right side lane marker, the visible indicia will be in the driver's line of sight in a position near the lane marker. If the driver steers the vehicle over the lane marker, the indicia should appear to be over the lane marker as well, in many embodiments. Some indicia include one or more line shaped portions which appear to converge and appear parallel to the lane marker. Other indicia may include one or more dots, which can be oriented in a line to appear parallel with the lane marker, and/or appear at different left to right positions with respect to the lane marker. Some indicia are light emitting devices, which can include fiber optic devices and/or LEDs.

### FIELD OF INVENTION

The present invention is related generally to motor vehicle accessories. More specifically, the present invention relates to devices for providing visual indication of proper vehicle lane placement to the vehicle's driver.

### BACKGROUND OF THE INVENTION

Safe driving of a motor vehicle requires that the vehicle be properly situated on the road.

In particular, the vehicle should be located within the lane, not over either right or left side lane markers, and preferably not too close to either lane marker. Inexperienced or new drivers often are uncertain of their driving ability, including accurately positioning their vehicles near an object, and have not yet developed a good feel for their exact vehicle position from side to side within a road lane. Drivers having diminished capacity due to medical problems may also at times have problems in properly judging proper vehicular lane position.

What would be desirable are methods and apparatus to aid a driver in evaluating and properly establishing his vehicle's lane position between the right and left side lane markers.

### SUMMARY OF THE INVENTION

The present invention provides a visual aid device for assisting a driver of a motor vehicle. Some embodiments of the visual aid device assist in properly positioning a motor vehicle within the lane of a road. Embodiments of the device may include a first visual indicia positioned on a vehicle windshield. The first visual indicia can be positioned such that a line extending from the driver's eyes through the first indicia projects out to a first location near a lane marker when the vehicle is properly positioned within the lane. The lane marker selected as a reference can be the right and/or left side lane marker, in various embodiments of the invention. In some embodiments, a second visual indicia is positioned on the vehicle windshield such that the driver's eyes view the second indicia along a more distant portion of the same set of lane markers.

In some embodiments of the present invention, the indicia includes at least one line shaped strand. Other embodiments can include at least one dot. Still other embodiments include two or more line shapes or two or more dots. Some embodiments include straight lines while other embodiments include curved lines. The indicia lines may be oriented to be substantially parallel to a lane marker when the car is on a long straight road. Some indicia embodiments include physical material adhered to the windshield. Other indicia embodiments include a light shining on the windshield.

The present invention includes methods for aiding a driver in determining proper road lane position. Embodiments of the method may include placing at least one indicia on the windshield such that the when the driver steers the vehicle to visually place the indicia near a road lane marker, the vehicle is near the proper lane position. The lane marker to be used with the invention is the left side lane marker in many embodiments of the invention, the right side lane marker in some embodiments, and both sides in other embodiments. In some embodiment methods, the indicia placement includes shining a light on the windshield. Some method embodiments include adhering a material to the windshield. Some adhered materials are reflective in visible light and/or fluorescing in ultraviolet light. Some embodiment methods include adhering a light emitting indicia to the windshield. Some light emitting indicia include fiber optics, internally reflective optical films, light pipes, and/or LEDs.

### BRIEF DESCRIPTION OF DRAWINGS

FIG. 1 is a perspective view of first embodiment of the invention in which a single line, suction cup applied version of the present invention is secured to a vehicle windshield, with the vehicle properly positioned with respect to the left side lane marker.

FIG. 2 is a perspective view of the embodiment shown in FIG. 1, wherein the vehicle is located too far to the right with respect to the left side lane marker.

FIG. 3 is a perspective view of a second embodiment of the invention wherein a two-line, suction cup applied version of the present invention is secured to a vehicle windshield.

FIG. 4 is a perspective view of a third embodiment of the invention wherein a single line, electrically powered, electronically illuminated version of the present invention is shown secured to a vehicle windshield.

FIG. 5 is a perspective view of a fourth embodiment of the invention wherein a three line, electrically powered, electronically illuminated version of the present invention is shown secured to a vehicle windshield.

FIG. 6 is a perspective view of a fifth embodiment of the invention wherein three single dot visual aids are shown disposed on the vehicle windshield and visually aligned with the left side lane markers on the road.

FIG. 7 is a perspective, forward looking view of a sixth embodiment of the invention wherein a light generating device, which is mounted adjacent the windshield, projects an optical visual aid indicia onto the vehicle windshield.

### DESCRIPTION OF THE PREFERRED EMBODIMENTS OF THE INVENTION

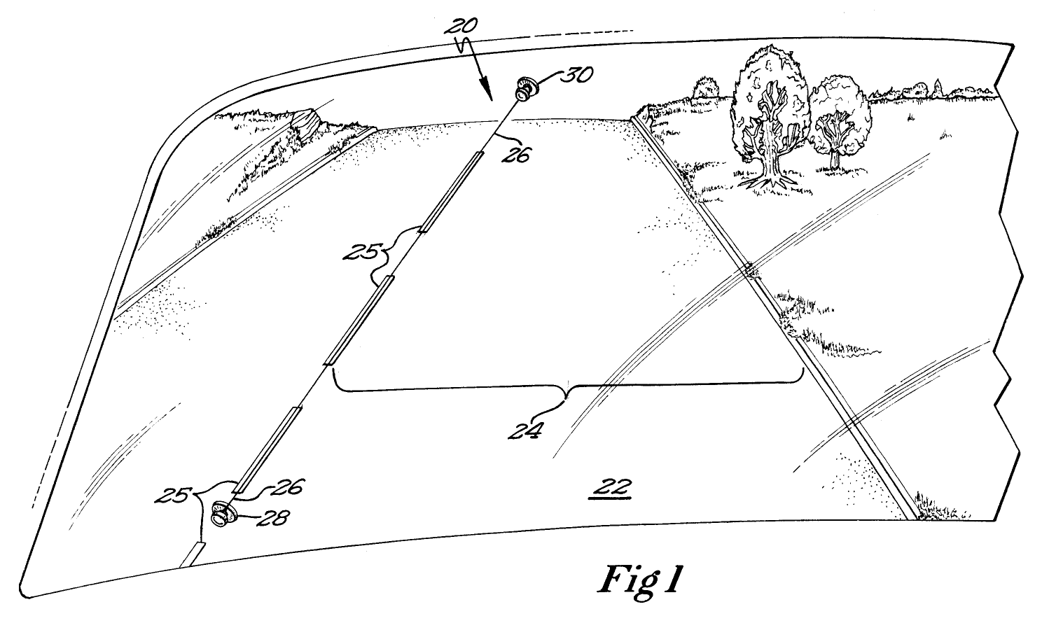

FIG. 1 illustrates a first embodiment of a single line shaped visual aid apparatus 20 including a lower suction cup 28, an upper suction cup 30, and a string or strand 26 extending therebetween. Suction cups 28 and 30 are applied to a vehicle windshield 22, which is part of the motor vehicle being driven. The left side lane markers 25 of the road may be seen to the left of a road lane 24. In this illustration, visual aid string 26 is aligned with left side lane markers 25, indicating that the vehicle is properly positioned within the lane 24. The string or strand 26 of some embodiments of the invention may be shorter than that illustrated in FIG. 1, as the lower portions of the visual aid apparatus are generally more accurate than the upper portions of the apparatus. In particular, roads do at times curve, making the upper portion of the strand, which would be positioned to line up with the more distant lane markers in a normal straight road, a less accurate guide than the lower portion of the strand, which more readily lines up with the lane markers which are situated nearer to the vehicle. In one example, on a left curving road, aligning an upper portion of the visual indicia with a distant lane marker may put the lower portion of the visual indicia to the left of the closer lane markers. Embodiments of the present invention are aids for proper vehicle placement, not a replacement for normal driver attentiveness.

One or more attachment devices are utilized to hold the string or strand 26 to the windshield. In some embodiments, the attachment devices used with visual aid string 26 will be suction cups 28 and 30. On other embodiments, the attachment device may be adhesive end portions on the string or an adhesive applied to either intermittent portions of the string or to the entire length of the string. Some embodiments use suction cups to properly position the visual aid line 26, followed by the use of adhesive tape to fix the string in place, followed by removal of the suction cups.

Some embodiments utilize the left side lane marker as a guide, others the right side lane marker, while still others utilize both right and left side lane markers. Only the left side visual aid indicia is illustrated in the present application, as the right side visual aid indicia does not require separate illustration.

The string or strand 26 used with the invention may be formed of any elongated strand-like material, including strings, threads, wires or other materials readily visible to the human eye, including materials of various color, and all such are within the purview of the invention. At times the string may be an elastic, stretchable one so as to avoid sagging of the string, and such is also within the purview of the invention. As is discussed further below, string 26 may be formed of, or include, light transmission devices, for example, fiber optics, optical films, or light pipes having a light transmission capacity. In one example, multiple small fiber optic strands of varying lengths will extend from lower suction cup 28 partially to top suction cup 30. The various fiber optic strands may terminate and even bend toward the driver in order to provide small pinpoints of visible light to create a lighted visual aid for night driving. In other embodiments, the fiber optic strand may terminate at various positions along the line, with a small reflector disposed near the fiber optic strand terminus to reflect at least some of the light toward the driver. In still other embodiments, the fiber-optic transmission may be somewhat “lossy.” In this way, some of the light will be lost along the length of the fiber optic strand or other light transmitting tubes

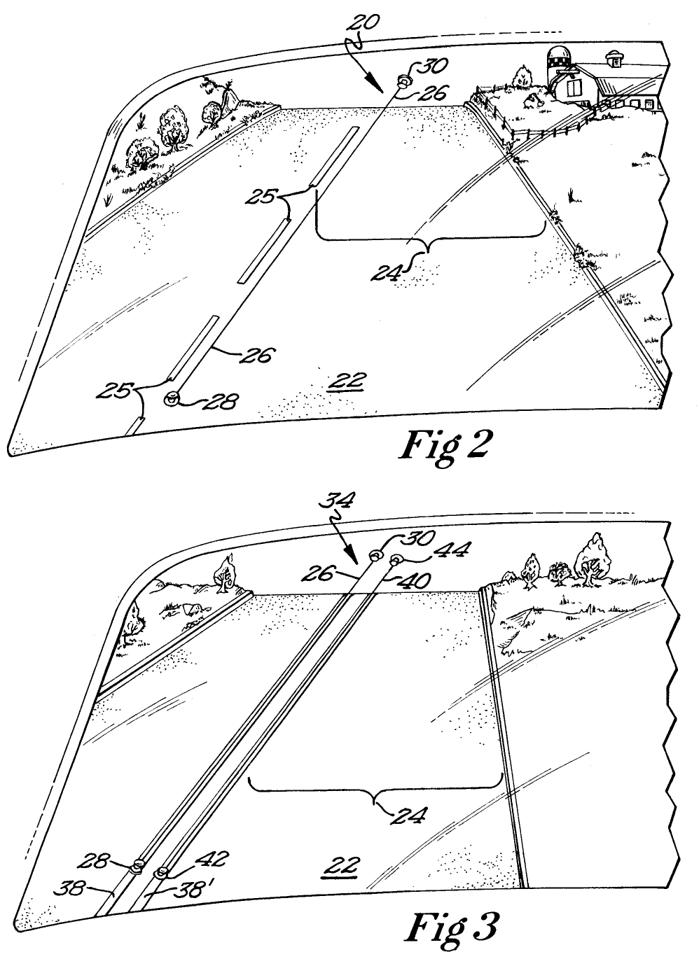

In use, the operator of the vehicle should position his head in his normal driving position, which may be with his head contacting the driver headrest. At that time, visual aid string 26 and suction cups 28 and 30 may be positioned such that visual aid string 26 properly overlays a lane marker of a road in the near foreground of the road as shown in FIG. 1, here the left side lane marker. One method for doing this is for the driver to park the vehicle in a large or medium-sized parking lot having several striped parking spaces outlined ahead of the driver, one after another. The left stripe may be used to approximate the left side lane marker of a road and at the operator's leisure to position the visual aid device indicia properly on the windshield. This will prove safer than attempting to do so while driving on an actual road. The driver's head should be properly positioned in a normal driving position, as changing the driver's head position will, of course, affect the on-road accuracy of the visual aid device. FIG. 1 illustrates the proper placement of the visual aid on the windshield and the appearance of the strand to the driver when the vehicle is properly positioned in the lane 24 relative to the lane markers 25 of a straight road. FIG. 2 illustrates the appearance from the driver's perspective of the visual aid embodiment 20 and string 26 when the vehicle has strayed too far to the right of left side lane markers 25 of the lane 24.

FIG. 3 illustrates another line shaped embodiment 34 of a visual aid apparatus having two strands. A first string or strand 26 with suction cups 28 and 30 as previously described with respect to FIG. 1 is positioned on the windshield of a vehicle. Apparatus 34 also includes a second string 40 extending between a lower suction cup 42 and an upper suction cup 44, the second string 40 being positioned substantially parallel to and spaced from string 26. The road left side lane markers 38 and 38′ are double white lines. In this embodiment, the two strings, 26 and 40 may be used to overlay both lane markers 38 and 38′, respectively. Alternatively, the strings 26 and 40 may be used to bracket a single lane maker such as marker 38′. In other uses, the double lines may be used to indicate a proper position when visual aid string 26 is aligned with the left side lane marker 38′ and to indicate a vehicle positioned too far left when string 40 approaches lane marker 38′.

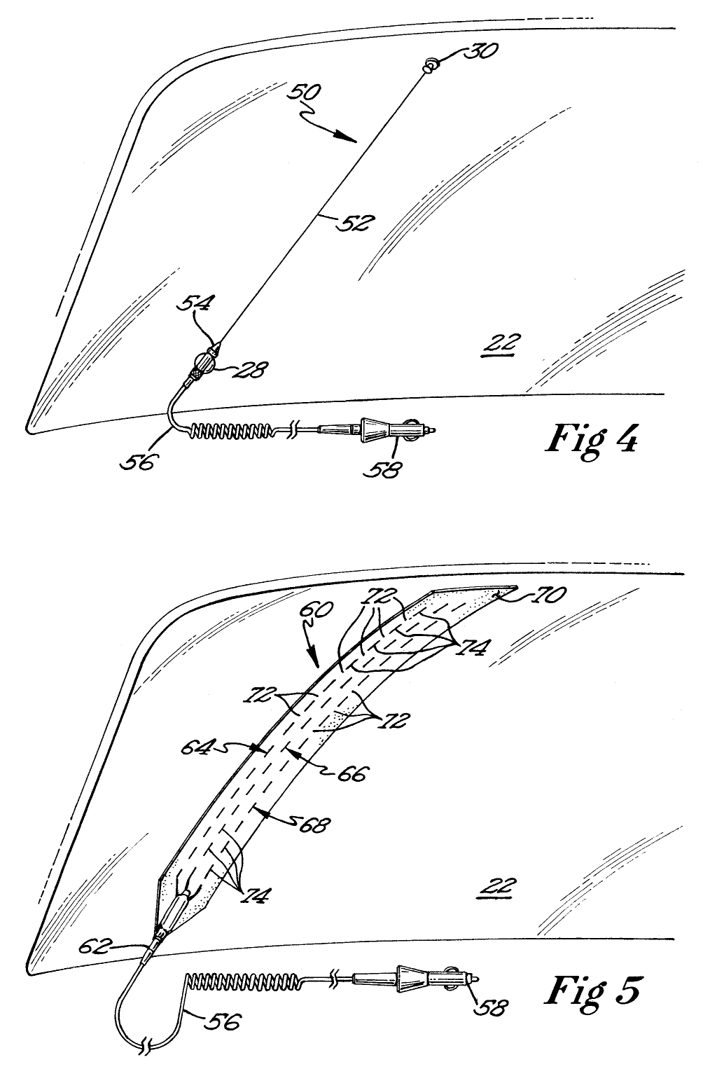

FIG. 4 illustrates another embodiment 50 of the visual aid apparatus. Embodiment 50 includes an illuminated or light emitting strand 52 which extends outwardly from housing 54. Illuminated strand 52 includes a light source, as for example, a light bulb or LED which is mounted in housing 54 and used to light strand 52 so the illuminated strand in effect emits light that will be readily visible to the driver. A power cord 56 extends from housing 54 and carries a twelve volt male power plug 58 of the type used with motor vehicle cigarette lighter receptacles or other twelve volt power inlets, and when so connected powers the light source. Alternatively, the light source can be hard wired to the electrical system of the motor vehicle. Illuminated strand 52 can include fiber optics, light pipe, internally reflective optical film, or combinations thereof. In some embodiments, illuminated strand 52 is alternately masked and clear to provide an alternating series of illuminated portions and dark portions for driving at night. Housing 54 and strand 52 can be adhered to the vehicle windshield 22 using adhesive and/or suction cup devices 28 and 30 and oriented and used as previously described.

FIG. 5 illustrates another embodiment 60 of the visual aid apparatus utilizing a thin, transparent film 70 having up to three illuminated or light emitting strands, 64, 66, and 68 embedded in or otherwise attached to the film 70. The film 70 may be formulated and attached in the way oil change reminder stickers are attached to vehicle windshields, and that mechanism or other alternative adhesives used with transparent film may be used with the invention as an attachment device. In the embodiment illustrated, strand 64 includes alternating masked, (non light emitting) portions 72 and light emitting portions 74. In embodiment 60, strands 66 and 68 also have the alternating light emitting portions. The strands may be formed of phosphorescent material or made of fiber optic material and then illuminated by a light source in housing 62. The light source may be a single bulb or LED or a series of LED's. In one version, each of the three strands 64, 66, and 68 have different colors from each other. In some embodiments, strand 64, farthest to the left, can be a red color, central strand 66 can be white, and right strand 68 green. In this way, different color strands can be used to indicate a dangerous position, a target, safe position, and a still safer position of the vehicle with respect to the left and/or right side lane markers. The light source in housing 62 is energized through power cord 56 and plug 58 as described earlier.

The visual aid apparatus shown in FIG. 4 may also be utilized without any light source 62 and without illuminated strands. In such a variation, the thin transparent film 70 will be provided with one or more easily visible lines similar to the lines 64, 66, and 68, but placed on the film by printing or any other known means. The film 70 is fastened to the windshield in any known manner, but is preferably adhered to the windshield 22 in the same manner as conventional oil change stickers are attached to windshields so as to make the film easily movable and adjustable for convenient alignment of the line or lines of the film with the road markers. While no illumination, per se, is contemplated in this variation of the invention, the line or lines may be colored or be printed using inks that are reflective or otherwise highly visible. With this variation of the invention and that described in the previous paragraph, the line or lines on the film may be either straight or may be provided with a gentle curvature similar to that shown in FIG. 4. Under some circumstances a gentle curvature can be helpful. In particular, some vehicle windshields have more side to side curvature than others, and providing an offsetting curvature of the lines on the film 70 allows the line or lines to appear to the driver to be generally straight when viewed by the driver from his normal driving position. In effect, by allowing some curvature of the line or lines on the film, the lines will appear to be substantially straight from the driver's perspective when the film is adhered to a vehicle windshield that also utilizes a side to side curvature.

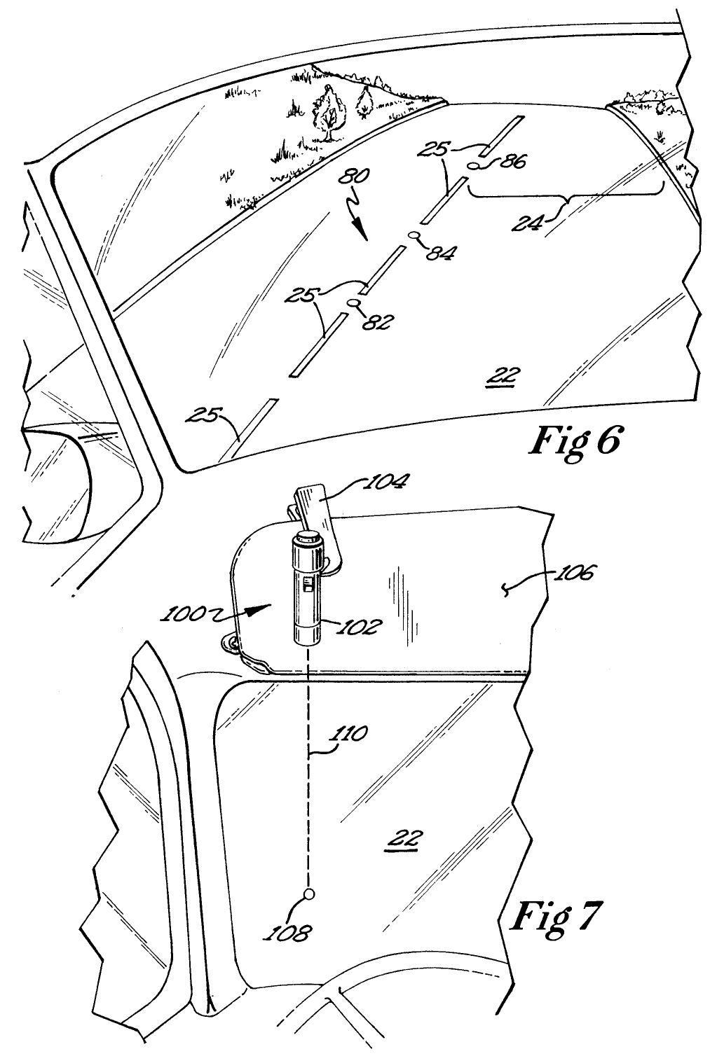

FIG. 6 illustrates yet another embodiment 80 of the visual aid apparatus, which utilizes a kind of virtual strand which is defined by one or more easily visible dots mounted to the inside of the vehicle windshield 22 to mark the proper lane position of the motor vehicle. The embodiment 80 is here illustrated with three such dots 82, 84 and 86. The dots may be formed of reflective material for improved night time visibility and illuminated by either ambient light or a small light mounted within the vehicle to better enhance visibility of the dots. Alternatively the dots may be formed of a material which fluoresces in ultraviolet light, so that a small, ultraviolet light source mounted in the vehicle cab can be used to significantly enhance the visibility of the dots and help the driver achieve the proper lane position at night. Alternatively, the dots can include LED's powered by small wires adhered to windshield 22 to enhance the night visibility of the dots. Dots 82, 84, and 86 will be positioned on the vehicle windshield 22 to line up with the road lane markers 25 as described for earlier embodiments, and used by the operator to more easily and safely position the vehicle. If desired, the dots may also be mounted on a thin transparent film of the type described earlier. The use of one or more dots can also be incorporated into the strand or string embodiments of FIGS. 1 through 5 of the present invention by positioning dots of highly visible material and of the general size shown in FIG. 6 along the strand 26.

FIG. 7 illustrates yet another embodiment 100 of the visual aid apparatus. Embodiment 100 includes a light projecting barrel 102, secured to a sun visor 106 with a clip 104. A light spot 108 is projected onto vehicle windshield 22 from barrel 102 along a light path indicated at 110. A small laser pointing device, an LED device, or other small, focused light source can be used to project a spot on the windshield to indicate the proper position of the vehicle within the lane. Alternatively more than one such light source may be used to project two, three, or more dots on the windshield to define a virtual strand properly marking the desired lane position.

In some embodiments of the invention, the visual aid apparatus is provided as an aftermarket item, to be fitted to existing vehicles long after sale. In other embodiments, the visual aid apparatus can be provided on the vehicle as original equipment at the time of sale. In one aftermarket embodiment, a visual aid apparatus such as that illustrated in FIG. 5, having cling film 70, can be installed in a manner analogous to the present installation of some rear window electric heat defogging devices, as are presently added to some vehicles. In some embodiments, the cling film behaves similarly to the cling film oil change reminder stickers presently use.

Various examples of apparatuses and methods have been presented in order to illustrate, not limit the present invention. It is anticipated that various modifications will occur to those skilled in the art without departing from the spirit and scope of the invention as defined by the following claims.

What is claimed is:

1. A method for aiding a driver in determining proper road lane position for a motor vehicle having a windshield, the method comprising:
the step of placing at least one visual indicia on the windshield in a position such that the when the driver steers the vehicle to visually place the indicia near a road lane marker the vehicle is near the proper lane position.

2. The method of claim 1, in which the step of placing the indicia includes shining a light onto the visual indicia.

3. The method of claim 1, in which the step of placing the indicia includes adhering the indicia to the windshield.

4. The method of claim 1, and further including the step of placing the driver's head in its normal driving position during the placing of the indicia on the windshield.

5. The method of claim 1, in which the step of placing the indicia includes fixing at least one line shaped portion of a material to the windshield to the left front of the driver.

6. The method of claim 1, in which the step of placing the indicia includes fixing at least one curved line shaped portions of a material to the windshield to the left front of the driver.

7. The method of claim 1, in which the step of placing the indicia includes fixing at least two line shaped portions of a material to the windshield to the left front of the driver.

8. The method of claim 1, in which the step of placing the indicia includes fixing at least one dot of a material to the windshield to the left front of the driver.

9. The method of claim 1, in which the step of placing the indicia includes fixing at least two dots of a material to the windshield to the left front of the driver.

10. The method of claim 1, in which the step of placing the indicia includes placing on the windshield at least two objects of different colors indicative of different vehicle distances with respect to the lane marker.

11. The method of claim 1, in which the step of placing the indicia includes placing a light reflecting material on the windshield.

12. The method of claim 1, in which the step of placing the indicia includes placing a light emitting object on the windshield.

13. The method of claim 1, in which the step of placing the indicia includes placing a fiber optic shaft on the windshield.

14. The method of claim 13, in which the step of placing the indicia includes placing at least one fiber optic shaft having alternating lighter and darker portions.

14. The method of claim 13, and further including the step of coupling the fiber optic shaft to a light source.

15. A visual aid apparatus useable with a motor vehicle having a windshield to assist a motor vehicle driver in properly positioning the motor vehicle on a road within a traffic lane having lane markers, the apparatus comprising:
a first visual indicia mountable on the vehicle windshield and positionable on the windshield such that a line of sight extending from the driver's eyes through the first indicia substantially projects out to at least one lane marker of the traffic lane when the vehicle is properly positioned within the lane on a substantially straight road.

16. The apparatus of claim 15, in which the lane marker is a left side lane marker, in which the visual indicia is positioned such that when the first indicia is in the driver's line of sight of the left side lane marker on a substantially straight road, the vehicle is in the proper lane position with respect to the left side lane marker.

17. The apparatus of claim 15, in which the visual indicia includes at least one line shaped indicia.

18. The apparatus of claim 17 wherein the said at least one line shaped indicia is gently curved to visually offset the curvature associated with a vehicle windshield when mounted to the windshield.

19. The apparatus of claim 17 wherein the said at least one line shaped indicia is straight.

20. The apparatus of claim 17 wherein the visual indicia includes a transparent film and said at least one line shaped indicia is carried by said film.

21. The apparatus of claim 15, in which the visual indicia includes at least one dot shaped indicia.

22. The apparatus of claim 15, in which the visual indicia includes at least a pair of line shaped indicia.

23. The apparatus of claim 15, in which the visual indicia includes at least a pair of dots.

24. The apparatus of claim 15, in which the visual indicia includes physical material adhered to the windshield.

25. The apparatus of claim 15, in which the visual indicia includes a light source aimed on the visual indicia.

26. The apparatus of claim 15, in which the visual indicia includes a light emitting fiber optic strand.

27. The apparatus of claim 15, in which the visual indicia includes an LED.

28. The apparatus of claim 15, in which the visual indicia includes two side by side, spaced apart strands to bracket the lane marker on both sides.

29. The apparatus of claim 15, in which the visual indicia includes three side by side indicia spaced apart to indicate a safer lane position, a target lane position, and a dangerous lane position with respect to the lane marker.

30. The apparatus of claim 15, further comprising a cling film secured to the indicia to releasably adhere the indicia to the windshield.

31. The apparatus of claim 15, further comprising at least one suction cup secured to the indicia to releasably adhere the indicia to the windshield.

32. A visual aid apparatus for assisting a motor vehicle driver comprising:
a motor vehicle having a windshield with an inner surface;
a road having a traffic lane;
the lane having a plurality of lane makers;
a visual indicia positioned on the inner surface of the windshield;
an attachment device for holding the first indicia to the windshield;
the attachment device being releasable from the windshield to allow aligning movement between the windshield and the visual indicia; and
the visual indicia being positioned on the line of sight connecting the head of the driver when the driver is in a normal driving position and a predetermined lane marker of the traffic lane;
whereby the driver can properly position and retain the motor vehicle in the traffic lane by keeping the visual indicia substantially lined up with at least one of the lane markers of the traffic lane on a substantially straight road.
